(19) United States
(12) Patent Application Publication
(10) Pub. No.: US 2016/0109741 A1
(43) Pub. Date: Apr. 21, 2016

(54) IN-CELL TOUCH DISPLAY SYSTEM, IN-CELL TOUCH PANEL AND TRACE LAYOUT THEREOF

(71) Applicant: Raydium Semiconductor Corporation, Hsinchu (TW)

(72) Inventors: Kun-Pei Lee, Zhunan Township (TW); Yu-Chin Hsu, Hsinchu City (TW); Yi-Ying Lin, Hualien City (TW)

(21) Appl. No.: 14/882,880

(22) Filed: Oct. 14, 2015

Related U.S. Application Data
(60) Provisional application No. 62/076,615, filed on Nov. 7, 2014.
(60) Provisional application No. 62/065,346, filed on Oct. 17, 2014.
(60) Provisional application No. 62/065,317, filed on Oct. 17, 2014.

(51) Int. Cl. G02F 1/1333; G02F 1/1343; G02F 1/1368; G02F 1/1335; G06F 3/041; G06F 3/044

(52) U.S. Cl. CPC G02F 1/13338; G06F 3/0412; G06F 3/044; G02F 1/1368; G02F 1/133514; G02F 1/133345; G02F 1/133512; G02F 1/134309; G06F 2203/04112

(57) ABSTRACT

An in-cell touch display system, an in-cell touch panel and its trace layout are disclosed. The in-cell touch panel includes a plurality of pixels. Each pixel has a laminated structure bottom-up including a substrate, a TFT layer, a first dielectric layer, a first conductive layer, a second dielectric layer, a second conductive layer, a liquid crystal layer, a color filter layer, and a glass layer. The first conductive layer or the second conductive layer is a part of a bridge structure. The bridge structure is disposed closed to a side near the TFT layer or near the liquid crystal layer.

### BACKGROUND OF THE INVENTION

1. Field of the Invention

This invention relates to a touch panel, especially to an in-cell touch display system, an in-cell touch panel, and a trace layout thereof.

2. Description of the Related Art

Please refer to FIG. 1. FIG. 1 illustrates an on-cell laminated structure of the capacitive touch panel. As shown in FIG. 1, the laminated structure 1 of the on-cell capacitive touch panel includes a substrate 10, a thin-film transistor layer 11, a liquid crystal layer 12, a color filtering layer 13, a glass layer 14, a touch sensing layer 15, a polarizer 16, an adhesive 17, and top lens 18.

From FIG. 1, the touch sensing layer 15 of the on-cell capacitive touch panel is disposed above the glass layer 14; that is to say, the touch sensing layer 15 is disposed out of the liquid crystal display module of the on-cell capacitive touch panel. Although the on-cell capacitive touch panel is thinner than the one glass solution (OGS), the on-cell capacitive touch panel already reaches its limit and fails to meet the requirement of thinnest touch panel design. Therefore it cannot be widely used in portable electronic products such as mobile phones, tablet PCs, and notebooks.

Therefore, the invention provides an in-cell touch display system, an in-cell touch panel, and trace layout thereof to solve the above-mentioned problems.

### SUMMARY OF THE INVENTION

A preferred embodiment of the invention is an in-cell touch panel. In this embodiment, the in-cell touch panel includes a plurality of pixels. A laminated structure of each pixel includes a substrate, a thin-film transistor layer, a first insulating layer, a first conductive layer, a second insulating layer, a second conductive layer, a third insulating layer, a liquid crystal layer, a color filtering layer, and a glass layer. The thin-film transistor layer is disposed above the substrate. The first insulating layer is disposed above the thin-film transistor layer. The first conductive layer is disposed above the first insulating layer. The second insulating layer is disposed above the first conductive layer. The second conductive layer is disposed above the second insulating layer. The third insulating layer is disposed above the second conductive layer. The liquid crystal layer is disposed above the third insulating layer. The color filtering layer is disposed above the liquid crystal layer. The glass layer is disposed above the color filtering layer.

In an embodiment, the first conductive layer and the second conductive layer are separated from the thin-film transistor layer and the first conductive layer and the second conductive layer are not integrated with the thin-film transistor layer.

In an embodiment, the in-cell touch panel is a self-capacitive touch panel or a mutual-capacitive touch panel.

In an embodiment, the first conductive layer and the second conductive layer are not coupled to a common voltage electrode.

In an embodiment, the first conductive layer or the second conductive layer is coupled to a common voltage electrode.

In an embodiment, the first conductive layer and/or the second conductive layer is a part of a bridge structure close to a side of the thin-film transistor layer or close to a side of the liquid crystal layer.

In an embodiment, the first conductive layer and the second conductive layer are separated from the liquid crystal layer by the third insulating layer.

In an embodiment, the in-cell touch panel is suitable for displays using in-plane switching liquid crystal (IPS) technology, fringe field switching (FFS) technology, or advanced hyper-viewing angle (AHVA) technology.

In an embodiment, the color filtering layer includes a color filter and a black matrix resist, and the black matrix resist has good light resistance.

In an embodiment, the first conductive layer and the second conductive layer are disposed under the black matrix resist.

In an embodiment, the first conductive layer and the second conductive layer are formed by a transparent conductive material or an opaque conductive material.

In an embodiment, the first conductive layer and the second conductive layer are coupled or not.

In an embodiment, the first conductive layer and the second conductive layer are aligned horizontally, perpendicularly, or in a mesh type.

In an embodiment, when the in-cell touch panel is a mutual-capacitive touch panel, a driving electrode of the mutual-capacitive touch panel is formed by the first conductive layer and the second conductive layer and a sensing electrode of the mutual-capacitive touch panel is the second conductive layer, or the sensing electrode of the mutual-capacitive touch panel is formed by the first conductive layer and the second conductive layer and the driving electrode of the mutual-capacitive touch panel is the second conductive layer.

Another preferred embodiment of the invention is also an in-cell touch panel. In this embodiment, the in-cell touch panel includes a plurality of pixels. A laminated structure of each pixel includes a substrate, a thin-film transistor layer, a liquid crystal layer, a color filtering layer, and a glass layer. The thin-film transistor layer is disposed above the substrate. A first conductive layer and a second conductive layer are integrated in the thin-film transistor layer. The second conductive layer is disposed above the first conductive layer. The liquid crystal layer is disposed above the thin-film transistor layer. The color filtering layer is disposed above the liquid crystal layer. The glass layer is disposed above the color filtering layer.

Still another preferred embodiment of the invention is an in-cell touch display system. In this embodiment, the in-cell touch display system includes an in-cell touch panel, a driving IC, and a touch IC. The in-cell touch panel can be the same with that in the two preferred embodiments mentioned above. The driving IC includes a common voltage selecting switch. The touch IC is coupled to the driving IC.

In an embodiment, when the in-cell touch panel is a fully in-cell touch panel, the first conductive layer or the second conductive layer is coupled to a common voltage or both the first conductive layer and the second conductive layer are not coupled to the common voltage.

In an embodiment, at least one transmitter electrode in the in-cell touch panel is electrically connected to the touch IC directly through at least one transmitter electrode trace and the touch IC is also electrically connected to the driving IC and selected whether to be switched to the common voltage or transmitting voltage; at least one receiver electrode in the in-cell touch panel is electrically connected to the driving IC directly through at least one receiver electrode trace and selected whether to be switched to the common voltage or receiving voltage.

In an embodiment, at least one transmitter electrode in the in-cell touch panel is electrically connected to a transmitting/receiving unit in the driving IC through at least one transmitter electrode trace and the transmitting/receiving unit is electrically connected to the touch IC, and the touch IC is also electrically connected to the driving IC and selected whether to be switched to the common voltage or transmitting voltage; at least one receiver electrode in the in-cell touch panel is electrically connected to the driving IC directly through at least one receiver electrode trace and selected whether to be switched to the common voltage or receiving voltage.

Compared to the prior arts, the in-cell touch panel of the invention uses the simplest designs of laminated structure and touch sensing electrodes to make the manufacturing become easier and reduce the cost. In addition, the touch electrodes are not integrated with the TFT components of the in-cell touch panel; therefore, the driving relationship between the TFT components and the touch electrodes can be simplistic to avoid the poor yield caused by the integration of the TFT components and the touch electrodes in the conventional in-cell touch panel. The entire performance and yield of the in-cell touch panel of the invention can be largely enhanced.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic diagram of the laminated structure of the conventional on-cell capacitive touch panel.

FIG. 2 illustrates a schematic diagram of the laminated structure of the in-cell touch panel in a preferred embodiment of the invention.

FIG. 3 illustrates a schematic diagram of the laminated structure of an embodiment of the touch component layer 22 of FIG. 2.

FIG. 4 illustrates a top view of the bridge structure B1 and the touch electrode 323 of FIG. 3.

FIG. 5 illustrates a schematic diagram of the laminated structure of another embodiment of the touch component layer 22.

FIG. 6 illustrates a top view of the bridge structure B2 and the touch electrode 321 of FIG. 5.

FIG. 7 illustrates a schematic diagram of the conductive layer having a mesh type pattern.

FIG. 8 illustrates a top view of the bridge structure of the mutual-capacitive touch electrodes.

FIG. 9 illustrates a top view of the touch electrodes and their traces.

FIG. 10 illustrates a schematic diagram of the in-cell capacitive touch panel using node type self-capacitive touch sensing technology.

FIG. 11 and FIG. 12 illustrate different connection ways of the touch sensing electrodes and their traces in the in-cell capacitive touch panel using node type self-capacitive touch sensing technology respectively.

FIG. 13 illustrates a schematic diagram of the laminated structure of the in-cell capacitive touch panel using node type self-capacitive touch sensing technology.

FIG. 14 and FIG. 15 illustrate schematic diagrams of different designs of the transmitter electrodes/receiver electrodes and the driving IC/touch IC of the fully in-cell touch panel in the in-cell touch display system respectively.

FIG. 16A and FIG. 16B illustrate signal waveforms of the conventional in-cell touch display system and the in-cell touch display system of the invention respectively.

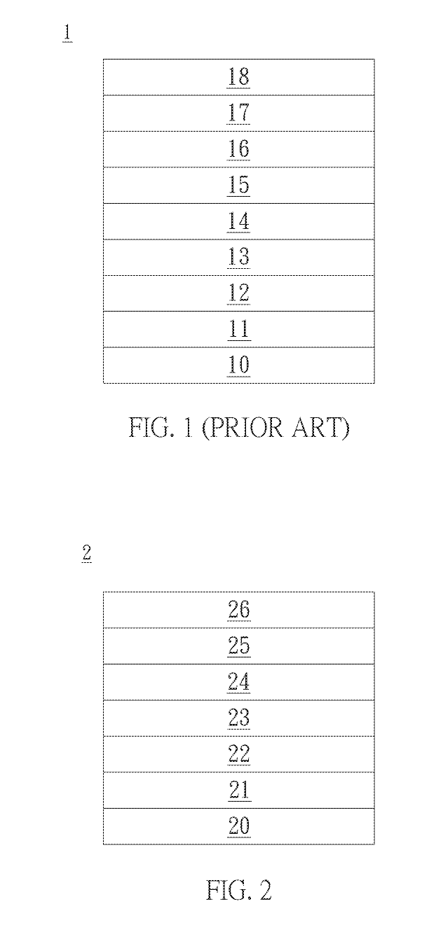

### DETAILED DESCRIPTION

A preferred embodiment of the invention is an in-cell capacitive touch panel. In practical applications, the in-cell capacitive touch panel can achieve thinnest touch panel design; therefore, it can be widely used in portable electronic products such as mobile phones, tablet PCs, and notebooks.

In this embodiment, the in-cell mutual-capacitive touch panel can be suitable for displays using in-plane switching liquid crystal (IPS) technology, fringe field switching (FFS) technology, or advanced hyper-viewing angle (AHVA) technology, but not limited to these cases.

In general, the most popular capacitive touch sensing technology in nowadays should be the projected capacitive touch sensing technology including a mutual-capacitive type and a self-capacitive type. As to the mutual-capacitive touch sensing technology, when a touch occurs, capacitive coupling will be generated between two electrode layers adjacent to the touch point, and the capacitance change between the two electrode layers will be used to determine the touch point. As to the self-capacitive touch sensing technology, when a touch occurs, capacitive coupling will be generated between the touch item and the electrode, and the capacitance change of the electrode will be used to determine the touch point.

It should be noticed that the in-cell capacitive touch panel in this embodiment can use a mutual-capacitive type touch sensing technology or a self-capacitive type touch sensing technology, and its touch electrodes can be distributed in a mesh type or other types based on practical needs to be used in self-capacitive type touch sensing or mutual-capacitive type touch sensing respectively.

In addition, in this embodiment, the touch electrodes are disposed between the TFT layer and the liquid crystal layer, so that the touch electrodes and the driving components (TFT components) of the display are disposed at the same side. However, the touch electrodes in this embodiment have independent structures without using any part of the TFT components. Therefore, the driving relationship between the TFT components and the touch electrodes can be simplistic to avoid the poor yield caused by the integration of the TFT components and the touch electrodes in the conventional in-cell touch panel.

Next, the laminated structure of the in-cell capacitive touch panel in this embodiment will be introduced in detail.

Please refer to FIG. 2. FIG. 2 illustrates a schematic diagram of the laminated structure of the in-cell capacitive touch panel in this embodiment. As shown in FIG. 2, in an embodiment, the laminated structure of the in-cell capacitive touch panel bottom-up includes a substrate 20, a TFT layer 21, a touch component layer 22, a liquid crystal layer 23, a color filter layer 24, a glass layer 25, and a polarizer layer 26. It should be noticed that the touch component layer 22 is disposed between the TFT layer 21 and the liquid crystal layer 23. The structure of the TFT layer 21 can be any possible designs without specific limitations. A semiconductor layer in the TFT layer 21 is formed by a semiconductor material such as low temperature poly-silicon (LTPS), indium gallium zinc oxide (IGZO), or amorphous silicon (a-Si), but not limited to these cases.

In this embodiment, the color filtering layer 24 includes a color filter CF and a black matrix resist BM. The black matrix resist BM has good light resistance and it can be used to separate three different color filters including a red (R) color filter, a green (G) color filter, and a blue (b) color filter. In addition, the black matrix resist BM can be also used to align the touch electrodes of the touch component layer 22 to shield the touch electrodes of the touch component layer 22. Therefore, the touch electrodes of the touch component layer 22 can be formed by a transparent conductive material or an opaque conductive material, and the aperture ratio of the pixels of the display will not be affected.

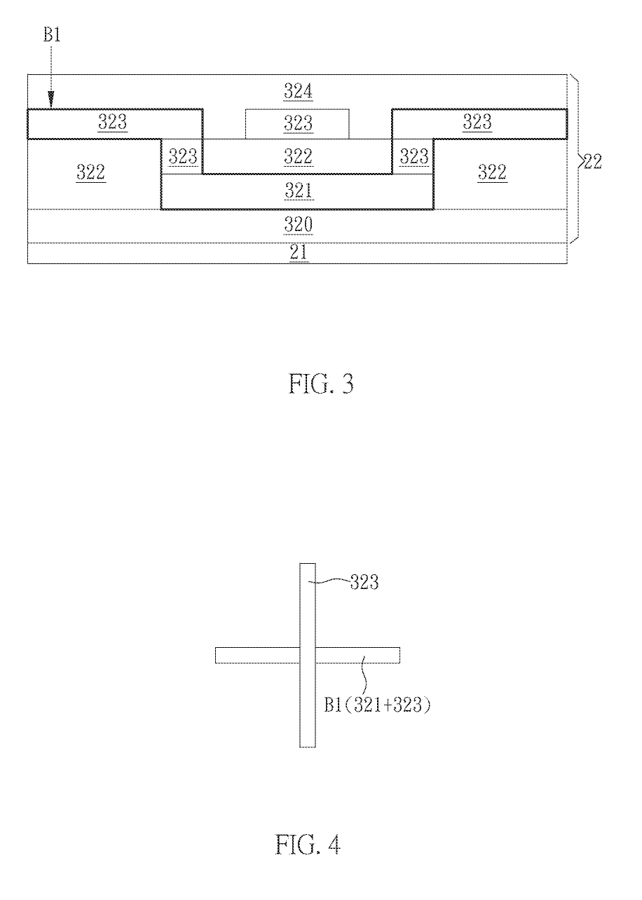

Then, please refer to FIG. 3. FIG. 3 illustrates a schematic diagram of the laminated structure of an embodiment of the touch component layer 22. As shown in FIG. 3, at first, an insulating layer 320 is formed above the TFT layer 21; and a conductive layer 321 is formed above the insulating layer 320; then, the conductive layer 321 is covered by an insulating layer 322; and a via is formed in the insulating layer 322; afterward, an conductive layer 323 is formed in the via and above the insulating layer 322, so that the conductive layer 323 formed in the via is electrically connected with the conductive layer 321 to form a bridge structure B1; at last, an insulating layer 324 is formed above the conductive layer 323. By doing so, the bridge structure B1 formed by the conductive layers 321 and 323 together is a touch electrode (e.g., X-axis sensing electrode), and it can bypass the conductive layer 323 of another touch electrode (e.g., Y-axis sensing electrode) from below to achieve the effect of bridging touch electrodes.

It should be noticed that the bridge structure B1 (e.g., X-axis sensing electrode) bypasses the conductive layer 323 (e.g., Y-axis sensing electrode) from below; therefore, the bridge structure B1 of this embodiment is close to the side of the TFT layer 21. Please refer to FIG. 4. FIG. 4 illustrates a top view of the bridge structure B1 and the touch electrode (the conductive layer) 323 of FIG. 3. As shown in FIG. 4, it is obvious that the bridge structure B1 bypasses the touch electrode (the conductive layer) 323 from below.

In practical applications, the conductive layers 321 and 323 can be formed by the same conductive material or different conductive materials. Similarly, the insulating layers 320, 322, and 324 can be formed by the same organic or inorganic insulating material or different organic or inorganic insulating materials. In addition, since the bridge structure B1 used as X-axis sensing electrode is formed by the conductive layers 321 and 323 together, it is believed that the sensing electrodes of the same direction can be formed by different conductive layers.

Then, please refer to FIG. 5. FIG. 5 illustrates a schematic diagram of the laminated structure of another embodiment of the touch component layer 22. As shown in FIG. 5, at first, an insulating layer 320 is formed above the TFT layer 21; and separated conductive layers 321 are formed above the insulating layer 320; then, the conductive layers 321 are covered by an insulating layer 322; and a via is formed in the insulating layer 322; afterward, an conductive layer 323 is formed in the via and above the insulating layer 322, so that the conductive layer 323 formed in the via is electrically connected with the conductive layer 321 to form a bridge structure B2. By doing so, the bridge structure B2 formed by the conductive layers 321 and 323 together is a touch electrode (e.g., X-axis sensing electrode), and it can bypass the conductive layer 321 of another touch electrode (e.g., Y-axis sensing electrode) from top to achieve the effect of bridging touch electrodes.

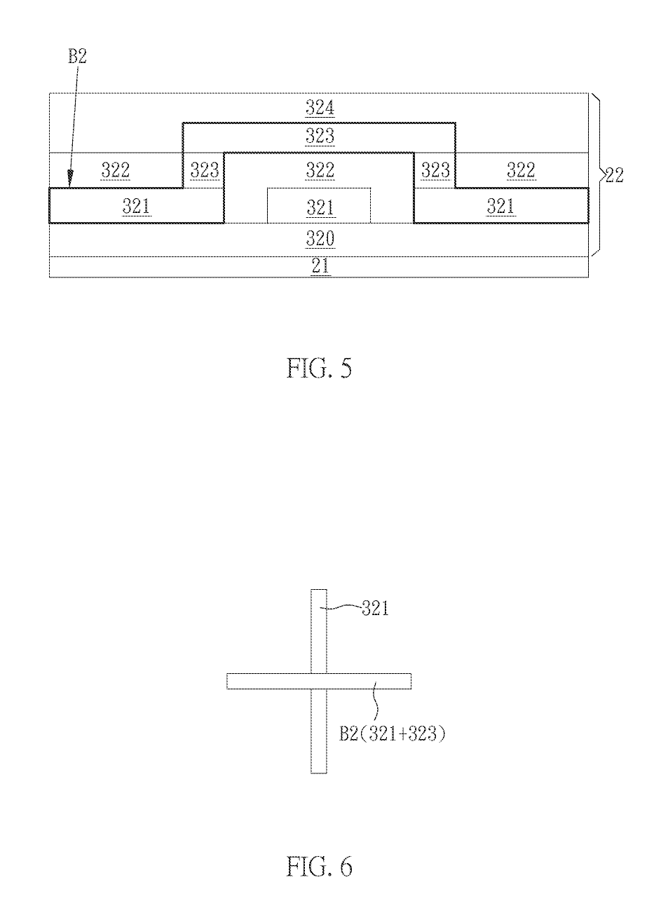

It should be noticed that the bridge structure B2 (e.g., X-axis sensing electrode) bypasses the conductive layer 321 (e.g., Y-axis sensing electrode) from top; therefore, the bridge structure B2 of this embodiment is close to the side of the liquid crystal layer 33. Please refer to FIG. 6. FIG. 6 illustrates a top view of the bridge structure B2 and the touch electrode (the conductive layer) 321 of FIG. 5. As shown in FIG. 6, it is obvious that the bridge structure B2 bypasses the touch electrode (the conductive layer) 321 from top.

Next, the pattern design of the touch electrodes in the touch component layer 22 will be introduced as follows.

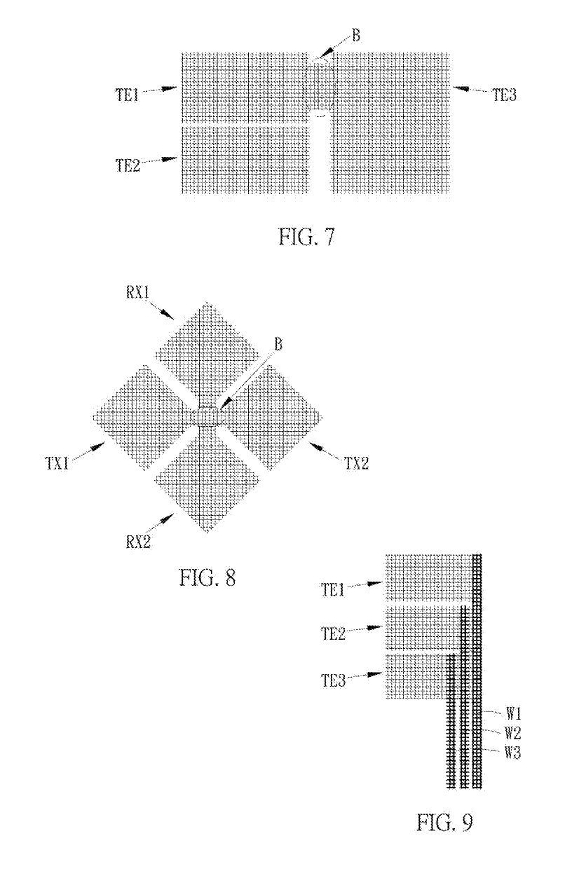

In this embodiment, the patterns of the touch electrodes are designed in mesh type, and the above-mentioned bridge structure B1 or B2 can be used to bridge the touch electrodes at suitable positions and the conductive layers can be disconnected to form open circuit. By doing so, the conductive layers in mesh type can be designed to be self-capacitive touch electrode or mutual-capacitive touch electrode based on practical needs. Please refer to FIG. 7. FIG. 7 illustrates a schematic diagram of the conductive layer having a mesh type pattern. As shown in FIG. 7, a first electrode area TE1 and a second electrode area TE2 are separated by disconnecting the conductive layers to form open circuit; since the B area is not disconnected, the first electrode area TE1 and the third electrode area TE3 are electrically connected.

Please refer to FIG. 8. FIG. 8 illustrates a top view of the bridge structure of the mutual-capacitive touch electrodes. As shown in FIG. 8, the first touch electrodes TX1 and TX2 are electrically connected to each other by the bridge structure B bypassing the second touch electrodes RX1 and RX2 from top.

Please refer to FIG. 9. FIG. 9 illustrates a top view of the touch electrodes and their traces. As shown in FIG. 9, the touch electrodes TE1˜TE3 and their traces W1˜W3 can be formed by the different conductive layers 321 and 323 respectively and applied to mutual-capacitive touch sensing or self-capacitive touch sensing based on different designs.

Another preferred embodiment of the invention is also an in-cell capacitive touch panel. In practical applications, the in-cell capacitive touch panel can achieve thinnest touch panel design; therefore, it can be widely used in portable electronic products such as mobile phones, tablet PCs, and notebooks.

It should be noticed that the in-cell capacitive touch panel is a node type self-capacitive touch panel using the node type self-capacitive touch sensing technology. Since touch electrodes are disposed on the substrate of the TFT layer through two conductive layers, the in-cell capacitive touch panel of this embodiment can have simplest design of laminated structure, and the designs of the touch electrodes and their traces are also simple; therefore, the in-cell capacitive touch panel of this embodiment is easy to be manufactured and the cost can be also reduced.

In this embodiment, the above-mentioned two conductive layers include a first conductive layer M1 and a second conductive layer M2. The first conductive layer M1 can be formed by any conductive material, and it can be aligned horizontally or perpendicularly. The first conductive layer M1 can be disposed under the black matrix resist to be shielded, but not limited to this case. The second conductive layer M2 can be formed by any conductive material, and it can be aligned horizontally, perpendicularly, or in a mesh type. The second conductive layer M2 can be disposed under the black matrix resist to be shielded, but not limited to this case. In fact, the first conductive layer and the second conductive layer can be electrically connected or separated from each other without any limitations.

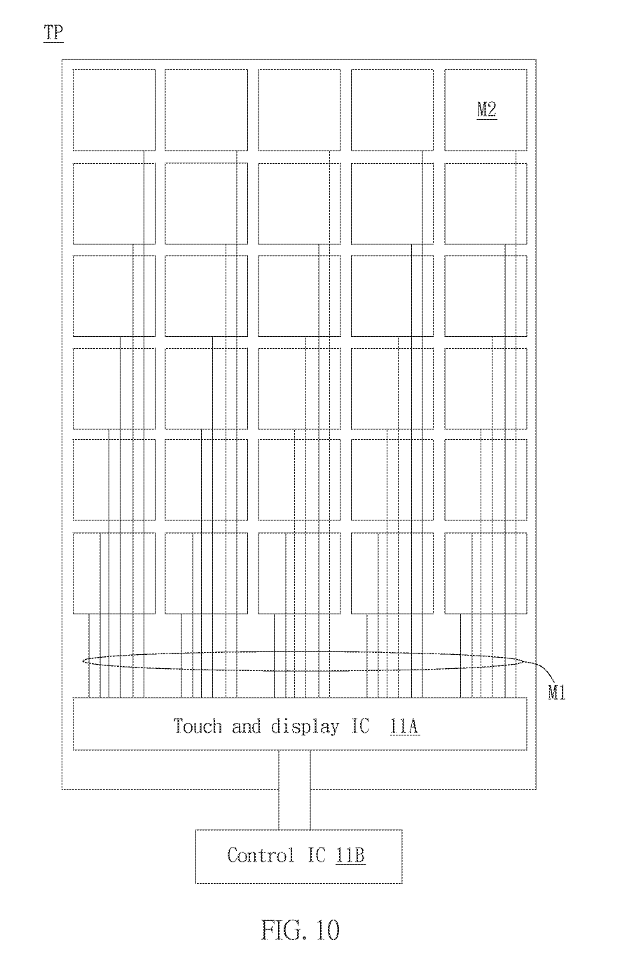

Please refer to FIG. 10. FIG. 10 illustrates a schematic diagram of the in-cell capacitive touch panel using node type self-capacitive touch sensing technology. As shown in FIG. 10, the in-cell capacitive touch panel TP includes touch sensing electrodes M2 and their traces M1 on the lower substrate. Each touch sensing electrode M2 is electrically connected to the touch and display IC 11A through its trace M1. It should be noticed that the touch IC and the display IC are integrated in the same chip in this embodiment, but they can be also separated from other in practical applications.

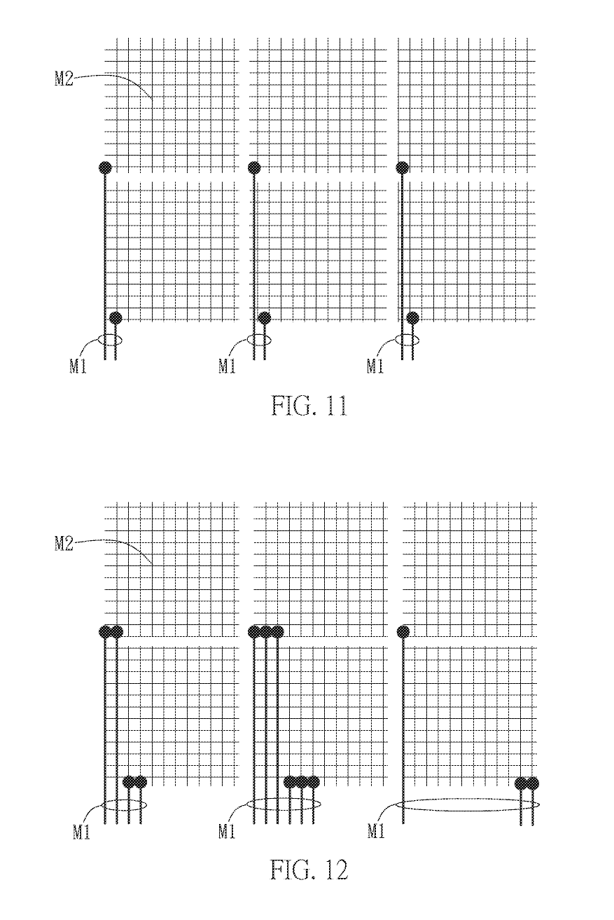

Then, please refer to FIG. 11 and FIG. 12. FIG. 11 and FIG. 12 illustrate different connection ways of the touch sensing electrodes and their traces in the in-cell capacitive touch panel using node type self-capacitive touch sensing technology respectively. From FIG. 11 and FIG. 12, it can be found that there will be a lot of ways for the connections between the touch sensing electrodes M2 and their traces M1. For example, each touch sensing electrode M2 can be connected with one trace M1 or more traces M1 and the connections between the touch sensing electrodes M2 and their traces M1 can be aligned symmetrically or not. Furthermore, the direction of each trace M1 can be straight or not without specific limitations.

It should be noticed that since the connections between the touch sensing electrodes M2 and their traces M1 are very flexible, it will be helpful to the impedance matching design of the in-cell capacitive touch panel.

Conventionally, when the touch sensing electrodes and their traces are disposed in the same layer, if the area of the touch sensing electrodes is maintained, the area of dead zone occupied by the traces will be too large, the accuracy of the touch sensing done by the in-cell capacitive touch panel will be affected; if the area of dead zone occupied by the traces is reduced, the areas of some touch sensing electrodes must be reduced, and the touch sensing electrodes will have different areas, the accuracy of the touch sensing done by the in-cell capacitive touch panel will be affected.

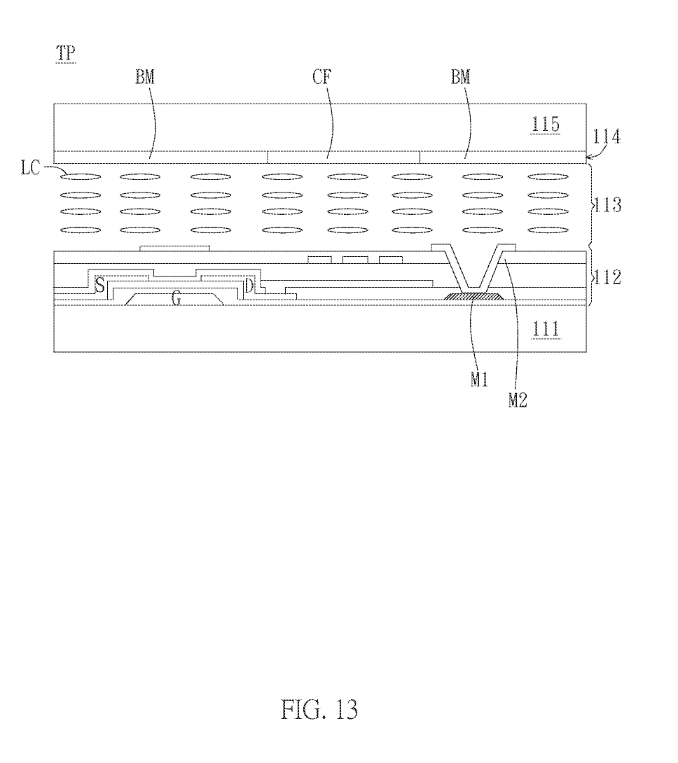

In order to overcome the above-mentioned drawbacks, as shown in FIG. 13, the conductive layers M1 and M2 are disposed in a top layer and a bottom layer respectively instead of being disposed on the same layer. That is to say, the touch sensing electrodes M2 and their traces M1 of the invention are not disposed in the same layer. Therefore, the drawbacks mentioned above such as too large area occupied by the traces and the touch sensing electrodes have different areas can be overcome by the invention, and the accuracy of the touch sensing done by the in-cell capacitive touch panel can be maintained.

It should be noticed that the relative location relationship between the conductive layers M1 and M2 in the laminated structure is not limited by FIG. 13. It can be designed in different ways based on different panel characteristics.

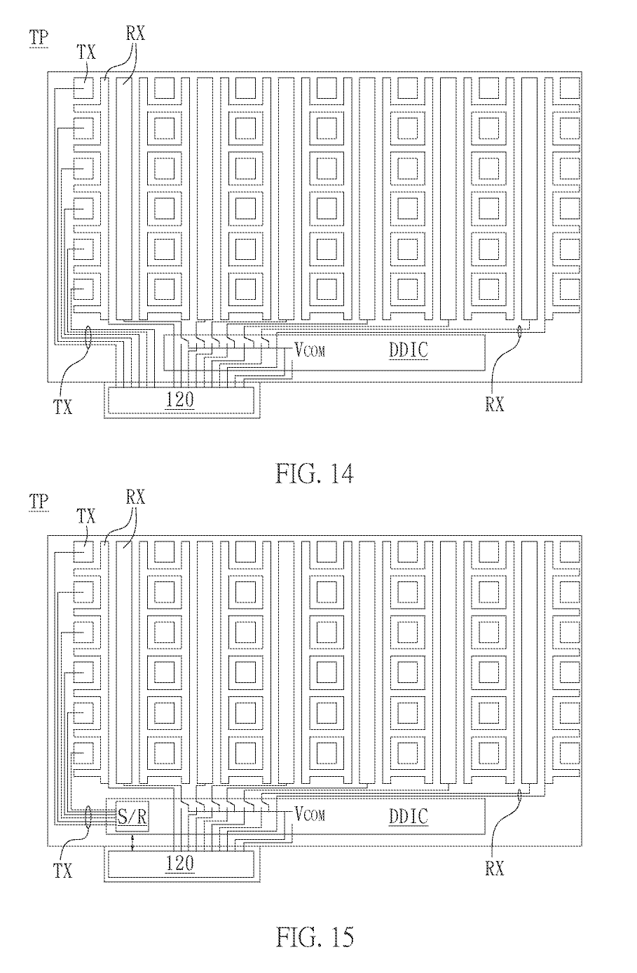

In another preferred embodiment of the invention, an in-cell touch display system is disclosed. In this embodiment, the in-cell touch display system includes an in-cell touch panel, a driving IC, and a touch IC. The in-cell touch panel can be a fully in-cell touch panel and the laminated structure of each pixel of the in-cell touch panel can be the same with that in the two preferred embodiments mentioned above, and the driving IC and the touch IC are redesigned and connected, but not limited to this case. In an embodiment, as shown in FIG. 14, the TX (transmitter) electrode in the in-cell touch panel TP is electrically connected to the touch IC 120 through the TX traces. The touch IC 120 is electrically connected to the driving IC DDIC and it can be selectively switched to the common voltage V_{COM}. The RX (receiver) electrode in the in-cell touch panel TP is electrically connected to the driving IC DDIC through the RX traces and it can be selectively switched to the common voltage V_{COM} or sensing voltage.

In an embodiment of the invention, the first conductive layer M1 or the second conductive layer M2 in the in-cell touch panel TP are coupled to the common voltage electrode or both the first conductive layer M1 or the second conductive layer M2 in the in-cell touch panel TP are not coupled to the common voltage electrode.

In another embodiment, please refer to FIG. 15, the TX electrode in the in-cell touch panel TP is electrically connected to a transmitting/receiving unit S/R in the driving IC DDIC through the TX trace and the transmitting/receiving unit S/R is electrically connected to the touch IC 120, and the touch IC 120 is also electrically connected to the driving IC DDIC and it can be selectively switched to the common voltage V_{COM}; the RX electrode in the in-cell touch panel TP is electrically connected to the driving IC DDIC directly through the RX trace and it can be selectively switched to the common voltage V_{COM} or sensing voltage.

In an embodiment of the invention, the first conductive layer M1 or the second conductive layer M2 in the in-cell touch panel TP are coupled to the common voltage electrode or both the first conductive layer M1 or the second conductive layer M2 in the in-cell touch panel TP are not coupled to the common voltage electrode.

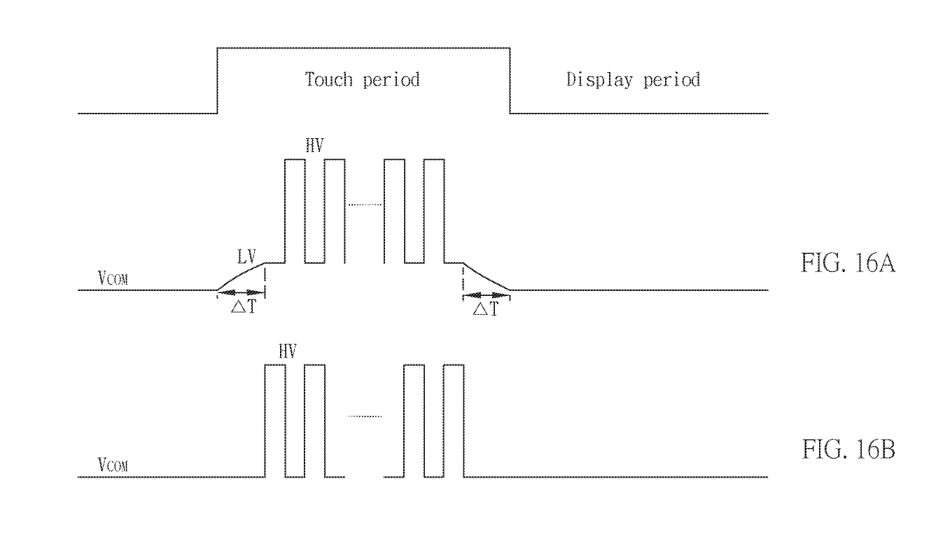

Please refer to FIG. 16A and FIG. 16B. FIG. 16A and FIG. 16B illustrate signal waveforms of the conventional in-cell touch display system and the in-cell touch display system of the invention respectively. After comparing FIG. 16A with FIG. 16B, it can be found that compared to the conventional in-cell touch display system, the in-cell touch display system of the invention can save the charging and discharging time ΔT including the charging time that the system signal is charged from the common voltage V_{COM} to the low voltage LV and the discharging time that the system signal is discharged from the low voltage LV to the common voltage V_{COM}. In addition, the in-cell touch display system of the invention can control the voltage level of the system signal more effectively.

Compared to the prior arts, the in-cell touch panel of the invention uses the simplest designs of laminated structure and touch sensing electrodes to make the manufacturing become easier and reduce the cost. In addition, the touch electrodes are not integrated with the TFT components of the in-cell touch panel; therefore, the driving relationship between the TFT components and the touch electrodes can be simplistic to avoid the poor yield caused by the integration of the TFT components and the touch electrodes in the conventional in-cell touch panel. The entire performance and yield of the in-cell touch panel of the invention can be largely enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An in-cell touch panel, comprising:
a plurality of pixels, a laminated structure of each pixel comprising:
a substrate;
a thin-film transistor layer disposed above the substrate;
a first insulating layer disposed above the thin-film transistor layer;
a first conductive layer disposed above the first insulating layer;
a second insulating layer disposed above the first conductive layer;
a second conductive layer disposed above the second insulating layer;
a third insulating layer disposed above the second conductive layer;
a liquid crystal layer disposed above the third insulating layer;
a color filtering layer disposed above the liquid crystal layer; and
a glass layer disposed above the color filtering layer.

2. The in-cell touch panel of claim 1, wherein the first conductive layer and the second conductive layer are separated from the thin-film transistor layer and the first conductive layer and the second conductive layer are not integrated with the thin-film transistor layer.

3. The in-cell touch panel of claim 1, wherein the in-cell touch panel is a self-capacitive touch panel or a mutual-capacitive touch panel.

4. The in-cell touch panel of claim 1, wherein the first conductive layer and the second conductive layer are not coupled to a common voltage electrode.

5. The in-cell touch panel of claim 1, wherein the first conductive layer or the second conductive layer is coupled to a common voltage electrode.

6. The in-cell touch panel of claim 1, wherein the first conductive layer and/or the second conductive layer is a part of a bridge structure close to a side of the thin-film transistor layer or close to a side of the liquid crystal layer.

7. The in-cell touch panel of claim 1, wherein the first conductive layer and the second conductive layer are separated from the liquid crystal layer by the third insulating layer.

8. The in-cell touch panel of claim 1, wherein the in-cell touch panel is suitable for displays using in-plane switching liquid crystal (IPS) technology, fringe field switching (FFS) technology, or advanced hyper-viewing angle (AHVA) technology.

9. The in-cell touch panel of claim 1, wherein the color filtering layer comprises a color filter and a black matrix resist, and the black matrix resist has good light resistance.

10. The in-cell touch panel of claim 9, wherein the first conductive layer and the second conductive layer are disposed under the black matrix resist.

11. The in-cell touch panel of claim 10, wherein the first conductive layer and the second conductive layer are formed by a transparent conductive material or an opaque conductive material.

12. The in-cell touch panel of claim 1, wherein the first conductive layer and the second conductive layer are coupled or not.

13. The in-cell touch panel of claim 1, wherein the first conductive layer and the second conductive layer are aligned horizontally, perpendicularly, or in a mesh type.

14. The in-cell touch panel of claim 1, wherein when the in-cell touch panel is a mutual-capacitive touch panel, a driving electrode of the mutual-capacitive touch panel is formed by the first conductive layer and the second conductive layer and a sensing electrode of the mutual-capacitive touch panel is the second conductive layer, or the sensing electrode of the mutual-capacitive touch panel is formed by the first conductive layer and the second conductive layer and the driving electrode of the mutual-capacitive touch panel is the second conductive layer.

15. An in-cell touch panel, comprising:
a plurality of pixels, a laminated structure of each pixel comprising:
a substrate;
a thin-film transistor layer disposed above the substrate, a first conductive layer and a second conductive layer being integrated in the thin-film transistor layer, wherein the second conductive layer is disposed above the first conductive layer;
a liquid crystal layer, disposed above the thin-film transistor layer;
a color filtering layer, disposed above the liquid crystal layer; and
a glass layer, disposed above the color filtering layer.

16. The in-cell touch panel of claim 15, wherein the first conductive layer and a source electrode and a drain electrode of the thin-film transistor layer are formed simultaneously.

17. The in-cell touch panel of claim 15, wherein the in-cell touch panel is a node type self-capacitive touch panel.

18. The in-cell touch panel of claim 15, wherein the first conductive layer and the second conductive layer are not coupled to a common voltage electrode.

19. The in-cell touch panel of claim 15, wherein the first conductive layer or the second conductive layer is coupled to a common voltage electrode.

20. The in-cell touch panel of claim 17, wherein the first conductive layer is a sensing electrode and the second conductive layer is traces, or the first conductive layer is the traces and the second conductive layer is the sensing electrode.

21. The in-cell touch panel of claim 20, wherein the sensing electrode is coupled to at least one trace of the traces and a direction of the at least one trace is straight or non-straight.

22. The in-cell touch panel of claim 15, wherein the color filtering layer comprises a color filter and a black matrix resist, and the black matrix resist has good light resistance.

23. The in-cell touch panel of claim 22, wherein the first conductive layer and the second conductive layer are disposed under the black matrix resist.

24. The in-cell touch panel of claim 23, wherein the first conductive layer and the second conductive layer are formed by a transparent conductive material or an opaque conductive material.

25. The in-cell touch panel of claim 15, wherein the first conductive layer and the second conductive layer are coupled or not.

26. The in-cell touch panel of claim 15, wherein the first conductive layer and the second conductive layer are aligned horizontally, perpendicularly, or in a mesh type.

27. An in-cell touch display system, comprising:
an in-cell touch panel, comprising:
a plurality of pixels, a laminated structure of each pixel comprising:
a substrate;
a thin-film transistor layer disposed above the substrate, a first conductive layer and a second conductive layer being integrated in the thin-film transistor layer, wherein the second conductive layer is disposed above the first conductive layer;
a liquid crystal layer, disposed above the thin-film transistor layer;
a color filtering layer, disposed above the liquid crystal layer; and
a glass layer, disposed above the color filtering layer;
a driving IC, comprising a common voltage selecting switch; and
a touch IC, coupled to the driving IC.

28. The in-cell touch display system of claim 27, wherein when the in-cell touch panel is a fully in-cell touch panel, the first conductive layer or the second conductive layer is coupled to a common voltage or both the first conductive layer and the second conductive layer are not coupled to the common voltage.

29. The in-cell touch display system of claim 27, wherein at least one transmitter electrode in the in-cell touch panel is electrically connected to the touch IC directly through at least one transmitter electrode trace and the touch IC is also electrically connected to the driving IC and selected whether to be switched to the common voltage or transmitting voltage; at least one receiver electrode in the in-cell touch panel is electrically connected to the driving IC directly through at least one receiver electrode trace and selected whether to be switched to the common voltage or receiving voltage.

30. The in-cell touch display system of claim 27, wherein at least one transmitter electrode in the in-cell touch panel is electrically connected to a transmitting/receiving unit in the driving IC through at least one transmitter electrode trace and the transmitting/receiving unit is electrically connected to the touch IC, and the touch IC is also electrically connected to the driving IC and selected whether to be switched to the common voltage or transmitting voltage; at least one receiver electrode in the in-cell touch panel is electrically connected to the driving IC directly through at least one receiver electrode trace and selected whether to be switched to the common voltage or receiving voltage.
